(19) United States
(12) Patent Application Publication
(10) Pub. No.: US 2022/0012791 A1
(43) Pub. Date: Jan. 13, 2022

(54) System and Method for Real-Time Garment Recommendations

(71) Applicant: Gil Elias, Hollywood, FL (US)

(72) Inventor: Gil Elias, Hollywood, FL (US)

(73) Assignee: Gil Elias, Hollywood, FL (US)

(21) Appl. No.: 16/925,881

(22) Filed: Jul. 10, 2020

(51) Int. Cl. G06Q 30/06; G06F 16/9535; G06F 16/2457; G06F 16/9538

(52) U.S. Cl. CPC G06Q 30/0631; G06F 16/9535; G06Q 30/0621; G06F 16/9538; G06F 16/24578

(57) ABSTRACT

The present invention includes a system and a method. The system, which automatically generates custom garment recommendations in real time, comprises a graphical user interface (GUI) configured for receiving and displaying different forms of data, a data storage module configured for storing data received from the GUI, and a processing module configured for coordinating data transfer, identifying a plurality of matching garments, determining a relevance score for each garment, and generating a list of recommended garments. The method automatically generates custom garment recommendations in real time for a shopper by receiving different forms of data on garments, receiving a request for a garment recommendation, identifying a plurality of matching garments, determining a relevance score for each identified garment, generating a list of a plurality of recommended garments ranked according to the relevance score for each, and displaying the list via a GUI.

### FIELD OF THE INVENTION

The invention relates to a system and method for recommending products in E-commerce, and more particularly for making real-time personalized recommendations on garments.

### BACKGROUND OF THE INVENTION

E-commerce generated over $600 billion in revenue in 2019 and now accounts for 10-15 cents of every retail dollar spent in the USA. Most US households comprise at least one internet user. Four in five internet users have purchased at least one good online. The value of global E-commerce retail is projected to exceed $4 billion in 2020. More growth lies ahead. A sizeable percentage of all online sales involves clothing. Ordering just one garment, however, and thus achieving a good fit and meeting the usual expectations of appearance and texture, is still all too rare. Obstacles lie in the way of satisfying customer expectations in online transactions.

Three barriers to efficient clothes E-marketing are notable. One, a clothing article that could fit an intended wearer might not actually fit, irrespective of a reasonable expectation based on nominal size (e.g. ‘medium’) or dimensions (e.g. 15-½″ neck, 35″ sleeves, 62 cm waist). Two, it is notoriously hard to represent key qualities of some articles of clothing in a usual catalog format. Three, when it comes to making a purchasing decision about clothes, many people consider the opinions of others just as important, if not more important, than their own opinion. For such reasons and others, current approaches to online clothes shopping are less efficient than they might be.

Counterintuitive effects of the inefficiency of clothing E-commerce must be noted. They include a shopper spending much more time and paying much more money to achieve a purchasing objective than necessary. People want shopping online to be less time-consuming and income-depleting than visiting a store. An obvious advantage for brick-and-mortar merchants is a clear disadvantage for online retailers. A downstream effect of the inefficiency of commerce on the world-wide web is an expansion in the volume of returned goods. This creates headaches for customers, reduces profits for retailers, and increases the carbon content of the atmosphere. As to returned garments in particular, they more problematic from a public health perspective than other returned goods, say, electronic devices. There is a need to improve the efficiency of online sales of clothing.

The names of social media platforms that barely existed in the first decade of the 21^{st} century are now household words. Many people, especially 10-to-30-year-olds, cannot image life without social media. That these platforms have come to influence retail sales is no surprise—in hindsight. Online promoters impact product awareness, sales and profits. Over half of all internet users thus come to know about at least one new brand or product a week. E-commerce platforms make it easier than ever for consumers to learn about and buy an ever-wider range of goods and services, at any time of day, any day of the week, virtually anywhere in the world. Exploring ways of harnessing the commercial potential of social media could potentially improve the efficiency of online clothing selling.

### SUMMARY OF THE INVENTION

In view of the foregoing, it is an object of the present invention and its embodiments in software applications to exploit certain features of social media platforms for E-commerce and thus address inefficiencies of online clothes retailing.

According to one embodiment of the invention, a system for automatically generating custom garment recommendations includes a graphical user interface (GUI) configured for receiving and displaying one or more of image data, numerical data and lexical data from a user device. The one or more of image data, numerical data and lexical data can include at least one attribute associated with a user. The at least one attribute can include one or more of an age, a sex, a size measurement, a body type, a skin tone, a garment brand, a garment size category, a garment type, a garment color, a garment material, a garment-identifying code, a price, and a user category. The user category can include one or more of a shopper, an ambassador and a merchant. The system can further include a data storage module configured for storing the data received from the GUI. The system can further include a processing module configured for coordinating transfers of data between the user, the GUI and the data storage module within a communications network, identifying a plurality of garments with at least one attribute matching an attribute associated with a shopper, determining a relevance score for each identified garment based on the number of matching attributes, and generating a list of a plurality of recommended garments ranked according to the relevance score of each identified garment with one or more of image data, numerical data and lexical data associated with each identified garment. The list can be displayed via the GUI on the user device associated with the shopper.

According to another embodiment of the invention, a method for automatically generating custom garment recommendations in real time for a shopper includes receiving one or more of image data, numerical data and lexical data related to a plurality of garment products from one or more ambassadors and merchants via corresponding forms of GUI. The one or more of image data, numerical data and lexical data can include at least one attribute associated with a garment product or an ambassador. The at least one attribute can include one or more of an age, a sex, a size measurement, a body type, a skin tone, a garment brand, a garment size category, a garment type, a garment color, a garment material, a garment-identifying code, and a price. The method can further include receiving a request for a garment recommendation from a shopper via a corresponding form of GUI. The request can include one or more of image data, numerical data and lexical data. The one or more of image data, numerical data and lexical data can include at least one attribute associated with the shopper. The at least one attribute can include one or more of an age, a sex, a size measurement, a body type, a skin tone, a garment brand, a garment size category, a garment type, a garment color, a garment material, a garment-identifying code, and a price. The method can further include identifying a plurality of garments having at least one attribute associated with the one or more ambassadors and merchants that matches at least one attribute associated with the shopper. The method can further include determining a relevance score for each identified garment based on the number of matching attributes. The method can further include generating a list of a plurality of recommended garments ranked according to the relevance score of each identified garment with one or more of the image data, numerical data and lexical data associated with each identified garment. The method can further include displaying the list via the GUI associated with the shopper.

These and other objects, aspects and advantages of the present invention will be better understood in view of the drawing and following detailed description of preferred embodiments.

### BRIEF DESCRIPTION OF THE DRAWINGS

FIG. 1 is a schematic of the connectivity an exemplary system, highlighting its four main sources of information—shoppers, ambassadors, merchants and financiers—and devices individuals within each class of information source can use to communicate via networks with the system and thus with each other;

FIG. 2 is a schematic of information flow an exemplary system, highlighting its main elements—a processing module, a graphical user interface (GUI) module, and a data storage module—data flow inward from sources of information, and data flow outward;

FIG. 3 displays exemplary screens A-F of GUIs for communication sessions between shoppers or ambassadors and a processing module of an exemplary system.

FIG. 4 shows a flowchart of a method of use of an exemplary system.

### DETAILED DESCRIPTION OF PREFERRED EMBODIMENTS

The specification discloses one or more embodiments of the present invention. The phrases ‘one embodiment’, ‘an embodiment’, ‘an exemplary embodiment’, etc., if included here, will indicate the corresponding embodiment may include a particular feature, structure, or characteristic of the present invention. Each embodiment will necessarily include a particular feature, structure, or characteristic of the present invention. The noted phrases will not necessarily refer to the same embodiment in all cases. Each embodiment will be understood to provide an example, instance, or illustration. Any embodiment or design described herein as “exemplary” should not necessarily be construed as preferred or advantageous over other embodiments or designs. The scope of the invention is not limited to the disclosed embodiment(s). Instead, the invention is defined by the claims appended hereto. When a particular feature, structure, or characteristic of the invention is associated with an embodiment, the description will be understood to fall within the knowledge needed for one skilled in the art to effect the feature, structure, or characteristic in association with other embodiments, regardless of whether an explicit description of other embodiments is provided herein.

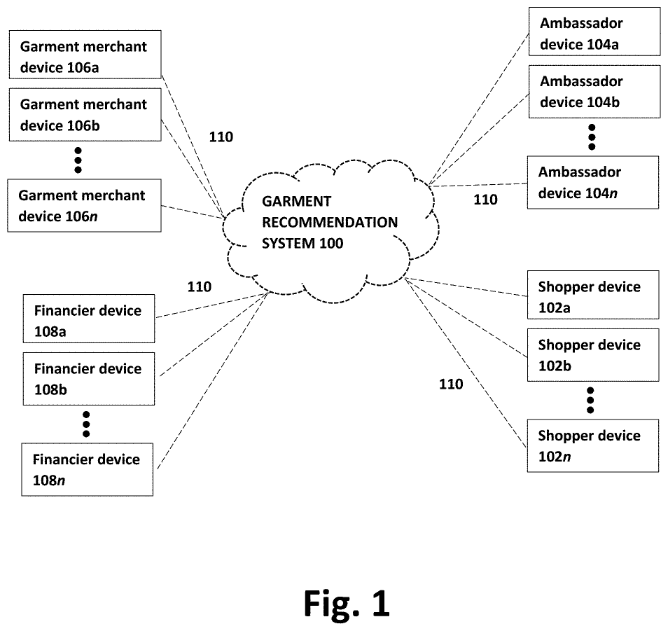

FIG. 1 shows an exemplary system 100 configured for receiving, storing, processing, sending and displaying data related to E-commerce in the clothing retail industry. The system 100 is configured for making garment recommendations based on several sources of information. The main sources of information are users of the system 100: one or more of a shopper for a garment (“a shopper”) 102, one or more of an ambassador for a related garment (“an ambassador”) 104, one or more of a merchant of a related garment (“a merchant”) 106, and one or more a financier of a transaction involving a garment (“a financier”) 108. Data are received from, sent to, or displayed on a respective device, 102a-n, 104a-n, 106a-n or 108a-n. Each main source of information and ‘device’ can be further defined.

A shopper 102 is a person (or a machine acting on behalf of a person) who can and does use any of a plurality of devices 102a-n to create, complete and submit a personal profile in the system 100. Information in a profile can and often does play a key role in garment purchase decisions, for example, age, sex, dimensions, style preferences, and the like. A completed profile will enable the shopper 102 to initiate an automated search for a garment for the person described in the profile. This person can be the shopper 102 herself, a family member of the shopper 102, or a friend of the shopper 102. Interaction of the shopper 102 with the system 100 is facilitated by a GUI.

An ambassador 104 is a person (or a machine acting on behalf of a person) who can and does use any of a plurality of devices 104a-n to create, complete and submit and post about a garment to the system 100. The post will contain personal comments on the garment. The post can influence the outcome of an automated search for a garment for a person described in a personal profile. The ambassador 104 will be rewarded for each post. Interaction of the ambassador 104 with the system 100 is facilitated by an ambassador GUI.

A merchant 106 is a person (or a machine acting on behalf of a person) who can and does use any of a plurality of devices 106a-n to provide to the system 100 or enable the system 100 to access generic product information and business rules about one or more garments. The merchant 106 can represent a corresponding garment retailer. For a given garment, generic product information can be a typical product description, for example, one containing data on color, size and material but devoid of personal perspective. The business rules can be price data, discount information, start and stop dates of promotions, revenue-sharing agreements, and the like. Interaction of the merchant 106 with the system 100 is facilitated by a merchant GUI.

A financier 108 is a person (or a machine acting on behalf of a person) who can and does use any of a plurality of devices 108a-n to facilitate an E-commerce transaction between a shopper 102 and a garment merchant 106 by an ambassador 104 on the system 100. The financier 108 can be a representative of a financial institution, for example, a bank. Interaction of the financier 108 with the system 100 is facilitated by a financier GUI.

For simplicity, ‘device’ is defined herein as any electronic component of the system 100 that can display an appropriately configured GUI of the system 100 on a monitor or screen. Many such devices will also comprise a processor, which can in turn be viewed as comprising a central processing unit, a communication bus, instant messaging tools, and other generic functional capabilities typically associated with modern communications devices. The devices 102a-n, 104a-n, 106a-n and 108a-n can be computers, desktop computers, laptop computers, tablets, smart phones, personal data assistants, and the like.

Components of the system 100 are connected to each other by one or more networks 110 (see FIG. 1). The networks 110 will include all necessary physical links and/or wireless links for effective signal transmission over a distance. Such physical links can include fiber optic cable, coaxial cable and Ethernet cable. Such wireless links can include radio frequency transmitters and receivers, wi-fi transmitters and receivers, cell phone antennas, satellite dishes and satellites.

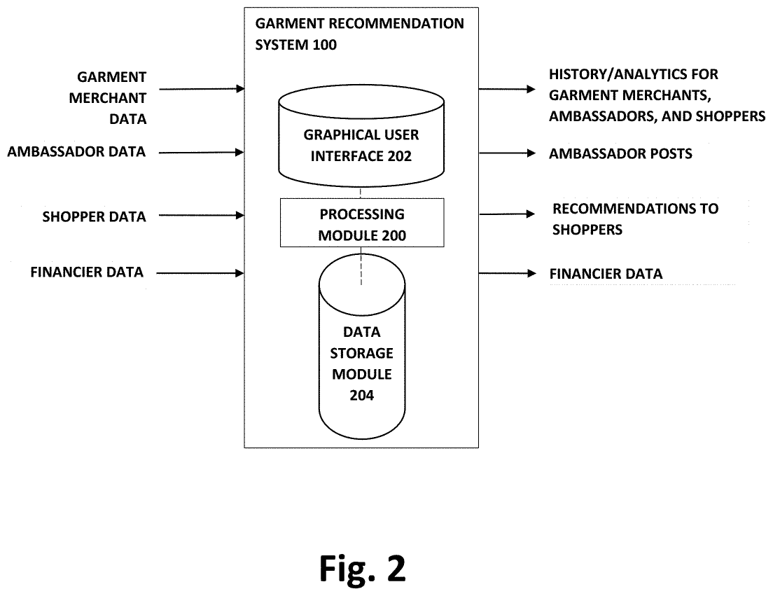

Referring to FIG. 2, an exemplary system 100 further comprises a processing module 200, a GUI 202 and a data storage module 204. The data storage module 204 comprises datafiles for the display of a GUI 202 on a device of a user of the system 100, for example, device 104a of ambassador 104. The data storage module 204 can store a plurality of electronic files on garments in the form of image data, numerical data and lexical data. The data can be from a garment merchant 106, an ambassador 104 or a shopper 102. The processing module 200 can transmit to a device of a user of the system 100 all corresponding data for GUI 202. The processing module 200 can make automated recommendations on garments to a shopper 102 on request, wherein the recommendations are based on settings of a personal profile, ambassador data and merchant data. The processing module 200 can also comprise a central processing unit, a communication bus, an E-mail server, instant messaging tools, and other generic functional capabilities commonly associated with modern electronic communications devices.

A user of the system 100 can use a corresponding GUI 202 to initiate a data communication session with the system 100. Each user of the system 100 is either unregistered and registered. There is only one category of unregistered user. An unregistered user can view only a limited number of functions in a GUI 202 (e.g., registration function). There are four categories of registered user in the system 100: shopper 102, ambassador 104, merchant 106 and financier 108 (cf. FIG. 1). Each of these categories corresponds to a main source of information of the system 100. Each category of registered user can view a corresponding set of functions in a GUI 202. A GUI 202 and its corresponding functions are delivered to a device of an unregistered user or any of the devices 102a-n, 104a-n, 106a-n or 108a-n of a registered user by the processing module 200.

An exemplary GUI 202 of a registered user can be configured to display content corresponding to the category of the registered user. Possible content includes visual content (images, videos), numerical content (size metrics) and lexical content (comments). Different categories of registered user can make use of devices in different ways and display customized features of the GUI 202 (e.g. GUI attributes, content, and content presentation) according to the category of user and the needs and preferences of the user.

An exemplary data communication session of a registered user with the system 100 involves a shopper 102. The shopper 102 makes use of functions of a corresponding form of GUI 202 to create a personal profile on the system 100. Another exemplary data communication session of a registered user with the system 100 involves an ambassador 104. The ambassador 104 makes use of functions of a corresponding form of GUI 202 to create and post personal comments on the system 100. Another exemplary data communication session of a registered user with the system 100 involves a merchant 106. The merchant 106 makes use of functions of a corresponding form GUI 202 to alter product catalog listings on the system 100. Another exemplary data communication session of a registered user with the system 100 involves a financier 108. The financier 108 makes use of functions of a corresponding form GUI 202 to enable or disable E-commerce functions accessible to the system 100.

The four main information sources of the system 100 are not necessarily mutually exclusive. The source names and part numbers designate roles individuals can play in relation to the system 100, not the essential natures of the individuals. For example, a shopper 102 can become an ambassador 104 by posting information about a garment to the system 100. A shopper 102 can thus become an ambassador 104. Similarly, a merchant 106 can also be a shopper 102 and an ambassador 104. A financier 108, too, can be a shopper 102, an ambassador 104 or a merchant 106.

In an exemplary embodiment, an intended post, to be valid in the system 100, comprises an image showing a shopper 102 wearing a garment, an original comment by the shopper 102 about the garment, and original responses by the shopper 102 to queries about the garment geared to give potential buyers a personal account of the garment. If the post is validated, the shopper 102 can become an ambassador 104.

Personal accounts of garments play an important role in the system 100. A personal account of a garment can provide insight on its qualitative aspects, for example, how it feels, how well it fits, occasions for which it seems best suited, and so on. Such aspects are not discussed in a typical merchant-generated description of a garment. For example, “a navy button-down shirt made of 85% cotton/15% polyester fabric, European cut, 15-½″ neck and 33″ sleeves,” though possibly 100% accurate, might give a poor sense of what many potential purchasers consider essential knowledge before deciding to buy.

In an exemplary embodiment, an intended post, once validated, is posted on the system 100. Validation makes a post accessible to registered users. The validation process includes ensuring a garment described in an intended post matches a garment shown in corresponding visual data, for example, a photograph or a video.

In an exemplary embodiment, each of a plurality of registered users of the system 100 is associated with a status. Different status designations have different levels of accessibility and/or capability related to the GUI 202 corresponding to the category of registered user. For example, the status of a shopper 102 depends on the number or cost of garments purchased in a time interval. The status of an ambassador 104 depends on one or more of the number of recommendations posted, the number of shoppers who have chosen to monitors posts submitted by the ambassador, and the number of garments sold to shoppers who have chosen to monitor the posts of ambassador. User status thus represents a level of achievement on, or experience with, the system 100.

In an exemplary embodiment of the system 100, a GUI 202 has a unique configuration for a shopper 102, an ambassador 104, a merchant 106 and a financier 108. The GUI 202 for a shopper 102 is configured to facilitate creation of a personal profile, garment identification and garment purchase. A shopper 102 can access a profile of the shopper 102 and a post of an ambassador 104. A shopper 102 can also shop for a garment marketed by a merchant 106. The GUI 202 for an ambassador 104 is configured to facilitate post creation, garment recommendation and garment promotion. An ambassador 104 can access a personal profile of the ambassador 104. An ambassador 104 can also prepare and submit a post on a garment of a merchant 106. The GUI 202 for a merchant 106 is configured to facilitate garment catalog accession and marketing. A merchant 106 can manage a proprietary product catalog and business rule settings pertaining thereto. The GUI 202 for a financier 108 is configured to facilitate E-commerce between a merchant 106, an ambassador 104 and a shopper 102. A financier 108 can access information on E-commerce transactions pertinent to the goods of a garment merchant 106.

In an exemplary embodiment of the system 100, each category of registered user can access corresponding analytical data from the data storage module 204. For example, a shopper 102 can access information about purchases made by the shopper 102 with the system 100, information about an ambassador 104 on the system 100, and so on. An ambassador 104 can access information about sales of a garment marketed by a merchant 106 in a post about the garment on the system 100, the number of followers of an ambassador 104 on the system 100, and so on. A merchant 106 can access information about sales of garments in the catalog of the merchant 106 accessible to the system 100, the number of followers of an ambassador 104 who promotes goods of the merchant 106 on the system 100, and so on. A financier can access information about E-commerce transactions involving the system 100, the volume of transactions involving a certain merchant 106, and so on.

A shopper 102 can use a corresponding GUI 202 of the system 100 displayed on a device 102a to view a post by an ambassador 104 on a garment of interest to shopper 102. An ambassador 104 can use a corresponding GUI 202 of the system 100 displayed on a device 104a to prepare and submit a post on a garment of possible interest to shopper 102. A merchant 106 can use a corresponding GUI 202 of the system 100 displayed on a device 106a to set a business rule on a garment or category of garments of possible interest to a shopper 102 or an ambassador 104. A financier 108 can use a corresponding GUI 202 of the system 100 displayed on a device 108a to configure an E-commerce tool to facilitate a transaction between a shopper 102 and a merchant 106. An ambassador 104 can influence a purchase decision of shopper 102 and thus be relevant to a transaction involving merchant 106.

The system 100 configured as described herein can uniquely enable a garment shopper 102, a garment ambassador 104, a garment merchant 106 and a financier 108 to engage in mutually advantageous E-commerce. The system 100 can thus influence how individuals of these general classes of person live, and it can add value to their lives.

The system 100 comprises a configurable processing module 200. The processing module 200 can be configured to receive and store a personal profile of a shopper 102 in a data storage module 204. The data provided by a shopper 102 can be archived according to a shopper identification number. In an exemplary embodiment, a shopper 102 is able to manage (create, update, delete) a profile. The processing module 200 can further be configured to match details of a profile of a shopper 102, a post of an ambassador 104, and a garment marketed by a merchandiser 106. Each garment search can be given an identification number. The processing module 200 can further be configured to store the results of a search or matching process initiated by shopper 102 in the data storage module 204. Stored data can be retrieved at a future time by a user, a shopper 102, an ambassador 104, a garment merchant 106 or a financier 108.

In one embodiment, the system 100 adds value to the life of a garment shopper 102 by connecting her to online and physical stores, offering her the results of a matching process carried out by a processing module 200 informed by an ambassador 104, providing her with valuable insight on the nature or suitability of a garment in-real time, and thus improving how she can make use of time. Further examples will illustrate how system 100 works.

In one embodiment, a shopper 102 has just accepted an invitation for a long hoped-for date—a few hours from now. A new outfit is needed, she feels. But this woman on the go is busy. Just the right garment, is needed, not just any garment. How will she be able to find it in time? The system 100 springs to mind. It is accessible from her fingertips. Ambassadors of garments on the system 100 have made many useful suggestions. They have an impact on what she finds “new,” “in vogue,” “rad,” “retro,” etc. She reviews the details of her personal profile, ensuring they indicate what she has in mind. And then, by a push of a single button, she implements processing module 200 of the system 100.

In an exemplary embodiment of the system 100, a processing module 200 is configured to help the shopper 102 cut to the chase. The processing module 200 feeds the shopper 102 suggestions on garments in rank order of relevance to the shopper 102. These are not merely garments a merchant 106 believes might look good on someone, often, someone with an idealized body, but garments shopper 102 can be confident will look good on her and fit well. This is because the processing module 200 has matched the personal profile created and modified by the shopper 102, which will include her dimensions and other important information pertinent to garment shopping, to recommendations informed by all ambassadors 104 the shopper 102 has selected. The profile of shopper 102 thus narrows the search for a garment via category settings on size, occasion, personality, material feel, material style, preferred ambassadors, and preferred brands or merchants. The shopper 102 will have specified not only a generic size category (e.g. petite) but also body type (e.g. mesomorph), dimensions (e.g. waist size in any usual length metric), the occasion for wear and other data that play a key role in a garment purchase decision; wherein ‘occasion’ means “general type of event in which a garment might be best suited,” ‘personality’ means “general sense a wearer might want to communicate to others by wearing a garment,” ‘material feel’ means “general tactile qualities of a garment,” ‘material style’ means “general visual qualities of a garment,” and ‘preferred brands or merchants’ means “garment brands or garment merchants an ambassador has a reason to value over other garment brands or merchants.” The processing module 200 compares specified attributes in her profile to attributes in ambassador 104-created posts and merchant 106-provided product descriptions. The matching process of the processing module 200 rank-orders the results of the comparison and recommends to the shopper 102 the best matches of her profile to posts of ambassadors 104 and descriptions of products of merchant 106. In an exemplary embodiment, the system 100 also gives the shopper 102 the option of collecting the from a store or having it shipped. The system 100 thus enables the shopper 102 make good use of time.

In another embodiment, the shopper 102 desires to identify a suitable garment for someone besides herself. She utilizes the system 100 to achieve the goal. She creates a personal profile for the intended wearer of a garment, for example, a family member or a friend. She selects ambassadors and/or garment brands she associates with the intended wearer. She then implements processing module 200 of the system 100 to match attributes and recommend possible garments in much the same way as if she were shopping for a garment for herself. The system 100 then generates a list of recommended garments. Finally, the shopper 102 buys a garment selected from the list.

In another exemplary embodiment, the system 100 promotes the sales of goods or services in a plurality of ways. For example, the system 100 alerts a shopper 102 to promotions on clothes in stores located nearby the physical location of the shopper 102. The system 100 also provides information on food and entertainment in relation to the physical location of the shopper 102. The system 100 does this by use of geolocation data for the device 102a of the shopper 102. The shopper 102 can selectively enable or disable certain types of recommendation in her profile settings.

In another exemplary embodiment, the system 100 provides lifestyle advantages for a garment ambassador 104. The ambassador 104 can promote a garment or brand to a plurality of shoppers 102 and thus potential buyers on the system 100. The system 100 thus functions in some respects as a social media network. The ambassador 104 makes use of the system 100 to create a post about a garment. The ambassador 104 earn points, or coins in a virtual bank account, in a rewards program for each post. He associates his post with a unique code for the garment featured in the post, for example, a UPC code or some other kind of product identifier. The system 100 makes use of geolocation data of the ambassador 104 to notify him of opportunities for commerce—nearby stores that accept points, offers, etc. The notifications are filtered by settings in the personal profile of the ambassador 104. He decides to redeem the points for merchandise, prepared food, entertainment or cash, depending on the need.

In another exemplary embodiment, an ambassador 104 comments on multiple different products in a single image posted on the system 100. Each product can be the subject of a separate post of the ambassador 104; the same image can appear in separate posts on the system 100. These posts, taken together, can form an ensemble of posts, representing an ensemble of garments selected by the ambassador 104. Garments of different brands can thus be combined in unique collections on the system 100, exploiting the apparel or fashion insights of the ambassador 104. A posted image and its description can include related wearable products, for example, earrings. Such products could provide sales and marketing opportunities beyond the immediate concern of a garment merchant 106 or an advertising agent for the garment merchant 106.

In another exemplary embodiment, the system 100 is configured to keep account of points earned by an ambassador 104. The points earned represent a value in a virtual bank account of the ambassador 104. The reward system of the system 100 comprises a formula to increase the value of the virtual bank account in relation to the number of times a shopper 102 views a video posted by the ambassador 104, the number of times a shopper 102 clicks on a hyperlink associated with ambassador 104, the number of sales of a garment promoted by the ambassador 104, and the number of licenses granted to, and/or value of license fees paid by, a third party (e.g. an advertising agency of a merchant 106) for use of ambassador 104-posted data, in many embodiments an image or video and comments, and in some embodiments an image or video and comments and an audio file. The amount credited to the virtual account of the ambassador 104 depends on whether a garment is sold to a pre-existing shopper or a new shopper 102 the ambassador 104 has recruited to the system 100.

In another exemplary embodiment, the value of a virtual bank account of an ambassador 104 can be redeemed in kind or in cash. For example, redemption in kind can be an exchange of virtual coins for a good or service from a business affiliate, e.g., a garment from a merchant 106. Redemption in cash can be a real deposit to a real account in a real bank.

In another embodiment, processing module 200 is configured to determine which store has in stock a garment of interest to a shopper 102. The processing module 200 determines a store where the garment is available within a shopper-specified radius or price range. Radius and price range are settings in the personal profile of the shopper 102.

In another embodiment, processing module 200 is configured to receive and store personal comments on a garment by an ambassador 104. For example, an ambassador device 104a can be used to obtain a photographic image or video, and the processing module 200 can be used to manage data provided by ambassador 104 to the system 100. Data management can comprise creating, uploading, updating, modifying, storing and deleting photographic, numerical or lexical data. Data management can comprise creating or deleting a post. Data of ambassador 104 can be archived on the system 100 according to an ambassador identification number. The ambassador 104 can retrieve the stored data later on.

In another embodiment, processing module 200 is configured to receive and store garment data from a garment merchant 106. The data provided by the garment merchant 106 can be archived according to merchant identification number and/or product code. The merchant 106 can make use of the system 100 to manage data, including uploading, updating, modifying, storing and deleting data in a garment catalog. The stored data can be retrieved later by the garment merchant 106.

In another embodiment, processing module 200 is configured to implement financial tools available from a financier 108 or store financial data of interest to the financier 108. The data can be stored in the data storage module 204. The financier 108 can make use of the system 100 to manage data or functions, for example, enable or disable tools that facilitate E-commerce. The processing module 200 can enable the storage of protocols for secure data transfer or the date, time, goods and prices pertinent to each E-commerce transaction involving the system 100. The data provided by an E-commerce financier 108 can be archived according to financier identification number. The stored data can be retrieved later by the financier 108.

There is a distinct class of person from shopper 102, ambassador 104, merchant 106 and financier 108 who can access the system 100 in another exemplary embodiment of the present invention. An individual of this class of this class of persons is neither an unregistered user nor a registered user of the system 100 as defined above. Instead, this person is an administrator. In general, an administrator as defined here will not be a source of information for the system 100 as described above. Still, an administrator of the system 100 will be able to view and modify information related to shoppers, ambassadors, merchants and financiers stored in the system 100. The general function of an administrator will be to ensure continuous and appropriate functionality of the system 100. An individual administrator of the system 100 could be a representative of an owner of a specific embodiment of the system 100.

‘Social network’, as used herein, means “an online social network or combination of online social networks involving different classes of people.” In relation to an embodiment of the system 100, the different classes of people of a social network involving the system 100 are different categories of user, unregistered or registered. There are four main classes of registered user of the system 100: a shopper 102, an ambassador 104, a merchant 106 or a financier 108. The system 100, as a social network, may have any number of registered users.

In an exemplary embodiment, the system 100 displays all such features and others generally associated with social networks. A shopper 102 and an ambassador 104 may interact with each other in the social network of the system 100 using corresponding devices, e.g., device 102a and device 104a. A social network operates within a communications network 110, for example, a local area network, wide-area network or combination of networks, for example, the internet. A social network can be based on the worldwide web. A communications network 110 enables certain forms of communication between a shopper 102, an ambassador 104 and a merchant 106 via the system 100. Possible ways whereby a registered user can communicate over the communications network 110 include but are not limited to blogging, discussion groups, E-mail, file sharing, instant messaging, online chat, video, voice chat, and so on.

Each shopper 102, ambassador 104 and merchant 106 of the system 100 has corresponding information. This information can include information the shopper 102, the ambassador 104 or the merchant 106 decides to communicate to other registered users of the system 100. For example, information corresponding to shopper 102 can include a name and/or an alias, a representative image (photographic image or avatar), contact information, status information, a list of interest, and the like. Selected information about an ambassador 104 can be configured to support a self-description page of the system 100 (a personal profile of ambassador 104). A shopper 102 can designate an ambassador 104 as a “friend” or “follow” ambassador 104, enabling the shopper 102 access to posts of ambassador 104.

In an exemplary embodiment, the system 100 provides an exchange for market intelligence and market influence. The system leverages social networks, web communities, and web technologies to enable an ambassador 104 to be an agent of change across the entire garment market vertical, from market research to advertising to sales. The system enables a shopper 102, an ambassador 104 and a garment merchant 106 to exchange data in ways that can improve products, sales, and customer experience.

The system 100 as thus embodied provides a means whereby an ambassador 104 can exert social influence by such means as opinion sharing, reviews, expert advice, endorsements, promotions, content generation and the like. A garment merchant 106 can use the system 100 to access information about an ambassador 104. An ambassador 104 can be rewarded for her ability to influence purchases of garments marketed by merchant 106.

Referring again to FIG. 1 and FIG. 2, a system 100 for real-time transmission of garment data and personal data, real-time comparisons of shopper attributes and other data, and real-time transmission of product and service recommendations includes a shopper 102, a shopper device 102a, an ambassador 104, an ambassador device 104a, a merchant 106 and a financier 108. The system 100 can be used to facilitate commerce involving the persons and devices just mentioned and stores, garments and a processing module 200, all located at different geographical sites. The shopper device 102a and the ambassador device 104a will be connected to the processing module 200 of the system 100 via one or more communications networks 110. The respective devices can establish separate communication sessions with the processing module 200 via the respective GUIs.

In an exemplary embodiment of the system 100, an ambassador GUI 202 comprises a mechanism whereby an ambassador 104 sends data to a processing module 200 by clicking a button on the ambassador GUI 202 displayed on an ambassador device 104a. A shopper GUI 202 comprises a mechanism whereby a shopper 102 sends data to the processing module 200 by clicking a button on the shopper GUI 202 displayed on the shopper device 102a.

In an exemplary embodiment, a camera on an ambassador device 104a is used to acquire an image or video of an ambassador 104 wearing a garment and an image of the UPC of the garment. The ambassador 104 then uses the ambassador device 104a to send the images and/or video to a processing module 200 of the system 100. The processing module 200 sends the images and/or video to the storage module 204. The ambassador 104 can further include the images and/or video of the garment in an intended post to the system 100. The post, once validated, is posted to the system 100. This post can include the images and/or video created by the ambassador 104.

In an exemplary embodiment, the GUI 202 on the shopper device 102a is used to access data posted to the system 100. For example, the shopper 102 uses the GUI 202 to create a personal profile. The shopper 102 implements a processing module 200 of the system 100 to generate a list of recommended garments. The shopper device 102a receives the list of recommended garments from the system 100. The shopper GUI 202 displays the recommendations on the shopper device 102a. The shopper 102 uses the shopper device 102a to view photographic, numerical and lexical information about a garment posted by an ambassador 102, for example, the data on the garment. The shopper 102 then decides whether or not to buy the garment and where to pick up the garment or have it shipped.

In an exemplary embodiment, a shopper 102 uses the GUI 202 on a corresponding shopper device 102a to place an order for a garment recommended by a processing module 200 of the system 100. When this occurs, order data are stored in the data storage module 204 and order data are forwarded to the corresponding garment merchant 106 for order fulfillment. For example, once the order is received by a warehouse server, the corresponding product can be shipped to the shopper 102 by any suitable transportation means.

In an exemplary embodiment, a shopper GUI 202 is configured for a first shopper 102 to buy a garment for a second shopper 102 (a “friend” of the first shopper 102) without the first shopper 102 having first to create a personal profile for the second shopper. Instead, the second shopper 102 enables the first shopper 102 to access data on how she shops (e.g. preferred brands of clothes) without allowing him to access other data of her profile, for example, body dimensions or shipping address. The first shopper 102 can then buy a garment for the second shopper 102 and pay the cost of shipping the garment to the second shopper 102 without him being able to access personal information in her profile.

In another embodiment, an artificial intelligence tool is implemented to enable a shopper 102 to display on a shopper GUI 202 what he might look like wearing a selected garment. This can enable the shopper 102 to make a more informed purchase decision and improve the efficiency of clothing E-commerce.

In an exemplary embodiment, a shopper 102 or an ambassador 104 uses a photographic device to capture an image of an optical, machine-readable code of a garment, a unique identifier of the garment. For example, the photographic device can be a camera on an iPhone, and the code can be a barcode or a QR code. The shopper 102 or ambassador 104 then uses a corresponding GUI 202 to upload the image to the system 100, which automatically locates corresponding product information on the garment. In another embodiment, the shopper 102 or the ambassador 104 enters lexical information into a corresponding GUI 202 in place of a photographic image of a machine-readable code. In one embodiment, the lexical information is the string of alphanumeric symbols corresponding to a barcode.

A GUI 202 of a shopper 102, an ambassador 104, a merchant 106 and a financier 108 can display a landing page, login page, registration page, contact information, password retrieve page, profile page, and the like. For example, the registration page can include first name, last name, gender (optional), location, and an avatar selection, email address, password, retype password, contact information, phone number, and additional email address, and the like.

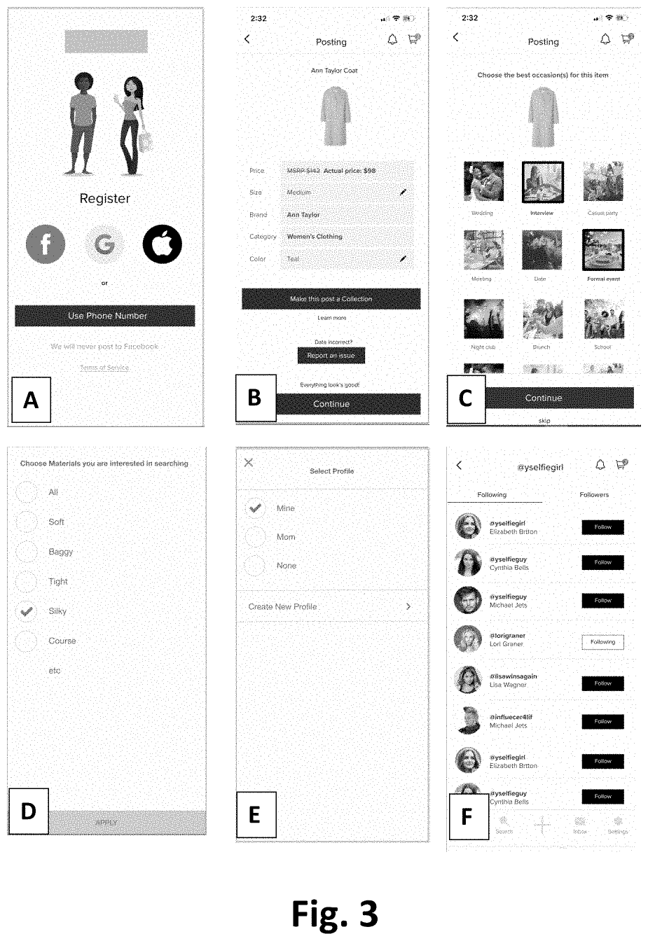

Referring now to FIG. 3, exemplary screens of a GUI 202 are shown in panels A-F. In one embodiment, displayed in panel A, the system 100 includes a landing page for an unregistered user to become a registered user. The registered user can be a shopper 102, an ambassador 104, a merchant 106 or a financier 108. Registration details can be saved and stored in a system memory 202. In another embodiment, the GUI 202 displays a screen to enable an ambassador 104 to prepare a post that will be accessible to registered users of the system 100. See panel B. The contents of the post can be saved and stored in a system memory 202. Panel C shows how an ambassador GUI 202 can facilitate preparation and submission of a post on a garment by an ambassador 104. In panel D, a shopper GUI 202 is configured to facilitate shopper 102 in identifying a desired garment. In one embodiment the shopper GUI 202 enables the shopper 102 to select from among one or more stored personal profiles. See panel E. Each profile can be configured to enable a shopper 102 or an ambassador 104 to modify the profile as desired. Panel F displays an embodiment of a shopper GUI 202 that facilitates a shopper 102 visualizing the ambassadors the shopper 102 is following for insight on clothing purchase options. There is drop-down list of all ambassadors 104 the shopper 102 follows. The list can include both ambassadors the shopper is following and all other ambassadors the shopper could follow. The shopper 102 can select a particular ambassador from the list and thus follow the ambassador 104.

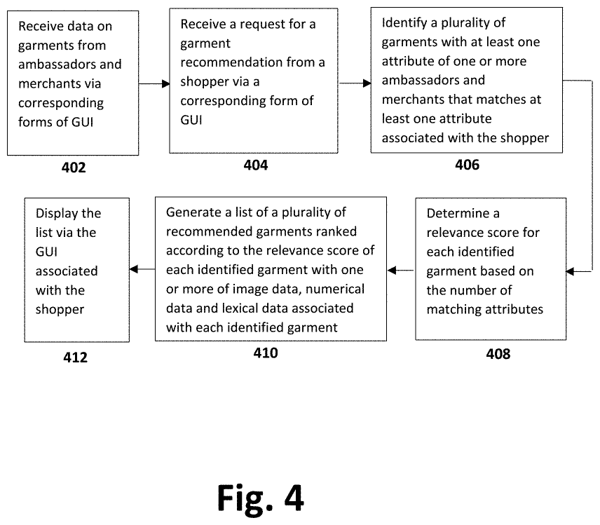

Referring to FIG. 4, a method of automatically generating custom garment recommendations in real time includes, at step 402, receiving one or more of image data, numerical data and lexical data related to a plurality of garment products from one or more ambassadors and merchants via corresponding forms of GUI, wherein the one or more of image data, numerical data and lexical data include at least one attribute associated with a garment product or an ambassador, and wherein the at least one attribute includes one or more of an age, a sex, a size measurement, a body type, a skin tone, a garment brand, a garment size category, a garment type, a garment color, a garment material, a garment-identifying code, and a price.

At step 404, a request is received for a garment recommendation from a shopper via a corresponding form of GUI, wherein the request includes one or more of image data, numerical data and lexical data, wherein the one or more of image data, numerical data and lexical data include at least one attribute associated with the shopper, and wherein the at least one attribute includes one or more of an age, a sex, a size measurement, a body type, a skin tone, a garment brand, a garment size category, a garment type, a garment color, a garment material, a garment-identifying code, and a price.

At step 406, a plurality of garments is identified with at least one attribute associated with the one or more ambassadors and merchants that matches at least one attribute associated with the shopper.

At step 408, a relevance score is determined for each identified garment based on the number of matching attributes.

At step 410, a list is generated of a plurality of recommended garments ranked according to the relevance score of each identified garment with one or more of image data, numerical data and lexical data associated with each identified garment.

At step 412, the list is displayed via the GUI associated with the shopper.

In an exemplary embodiment, the multi-step method outlined in FIG. 4 is extended by adding several steps after step 412. These include, in order, 1) the shopper 102 selecting a garment from a plurality of recommended garments, enabling her to view detailed information about the garment, including data provided by the merchant 106 and an ambassador 104; 2) the shopper 102 implementing a process to purchase the selected garment and select a delivery option, for example, collecting the garment from a store or having the garment delivered to a desired location; 3) the system 100 implementing tools of a financier 108 to enable a transaction involving the selected garment, for example, an E-commerce transaction; 4) the system 100 informing the garment merchant 106 of the purchase involving shopper 102 and ambassador 104 and of the selected delivery option; 5) the processing module 200 increasing the virtual bank account of ambassador 104 by an amount that reflects details of the purchase made by shopper 102; and 6) the system 100 providing the shopper 102 with confirmation of the purchase and related shipping information.

The processing module described in connection with the embodiments disclosed herein can include a set of instructions that can be executed to cause the processing module to perform any one or more of the methods or computer-related functions disclosed herein. The term ‘processing module’ in this context shall be taken to include any collection of systems or sub-systems that individually or jointly execute a set, or multiple sets, of instructions to perform one or more computer functions.

The present processing module, or any portion thereof, can operate as a standalone device or may be connected, e.g., using a network, to other computer systems or peripheral devices. In a networked deployment, the processing module can operate in the capacity of a server, such as a video server or application server, or a media device. The processing module can also be implemented as or incorporated into various devices, such as a personal computer (PC), a personal digital assistant (PDA), a mobile device, a palmtop computer, a laptop computer, a desktop computer, a communications device, a wireless telephone, a web appliance, a network router, switch or bridge, or any other machine capable of executing a set of instructions (sequential or otherwise) that specify actions to be taken by that machine. In a particular embodiment, the processing module can be implemented using electronic devices that provide voice, video or data communication.

The present processing module can include a central processing unit, a graphics-processing unit, or both. Moreover, the processing module can include a main memory and a static memory that can communicate with each other via an information bus. The processing module can include an input device, such as a keyboard, and a cursor control device, such as a mouse. The processing module can also include a disk drive unit, a signal generation device, such as a speaker or remote control, and a network interface device.

The GUI described in connection with the embodiments disclosed herein may be accessible via a web browser. As an example, the back-end for the GUI can be developed using the ASP.NET MVC 5 framework with a MS SQL Server 2012 database and the Entity Framework. The front-end of the GUI can be based on HTML5 web sockets for video and text communication. The video display unit of the GUI can be a liquid crystal display (LCD), a flat panel display, a solid-state display or some other type of display. Text communication can make use of SignalR v.2, and the video and/or audio communication can make of use WebRTC with a wrapper (e.g., OpenTok, XSockets.Net). The GUI can be hosted on a Microsoft Azure cloud platform or another platform.

The steps of a method or algorithm described in connection with the embodiments disclosed herein may be embodied directly in a hardware module accessed by the processing module, in a software module executed by the processing module, or in a combination of hardware and software. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processing module such that the processing module can read information from, and write information to, the storage medium. In the alternative, the storage medium may be integral to the processing module. The processing module and the storage medium may reside in an application-specific integrated circuit (ASIC). The ASIC may reside in a computing device or a user terminal. In the alternative, the processing module and the storage medium may reside as discrete components in a computing device or user terminal.

Those of skill in the art will appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The disclosed embodiments presented herein are intended to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined herein.

What is claimed is:

1. A system for automatically generating custom garment recommendations in real time, the system comprising:
a graphical user interface (GUI) configured for receiving and displaying one or more of image data, numerical data and lexical data from a user device, wherein the one or more of image data, numerical data and lexical data include at least one attribute associated with a user, wherein the at least one attribute includes one or more of an age, a sex, a size measurement, a body type, a skin tone, a garment brand, a garment size category, a garment type, a garment color, a garment material, a garment-identifying code, a price, and a user category, and wherein the user category includes one or more of a shopper, an ambassador and a merchant;
a data storage module configured for storing the data received from the GUI; and
a processing module configured for
coordinating transfers of data between the user, the GUI and the data storage module within a communications network;
identifying a plurality of garments with at least one attribute matching an attribute associated with a shopper;
determining a relevance score for each identified garment based on the number of matching attributes; and
generating a list of a plurality of recommended garments ranked according to the relevance score of each identified garment with one or more of image data, numerical data and lexical data associated with each identified garment, wherein the list is displayed via the GUI on the user device associated with the shopper.

2. The system of claim 1, wherein the one or more of image data, numerical data and lexical data received from the garment ambassador include a personal view of occasion, personality, material feel, material style, and preferred brands or merchants.

3. The system of claim 1, wherein the image data, numerical data and lexical data are received in real time from respective user devices associated with one or more shoppers, ambassadors and merchants.

4. The system of claim 1, wherein the image data include one or more of a photograph of a garment, a video of a garment, and a photograph of a machine-readable identification code corresponding to a garment.

5. The system of claim 1, wherein the lexical data include an alphanumeric representation of the identification code corresponding to a garment.

6. The system of claim 1, wherein the image data include one or more color images or videos of an ambassador wearing a garment.

7. The system of claim 1, wherein the numerical data include one or more of a size designation and a size metric of a garment.

8. The system of claim 1, wherein the numerical data include a weight, a height, a chest size, a waist size, a hip size and a sleeve length of a shopper or an ambassador.

9. The system of claim 1, wherein the lexical data include one or more keywords on a style, a color and a texture of a garment.

10. The system of claim 1, wherein the lexical data include one or more keywords on an occasion for which a garment is best suited.

11. The system of claim 1, wherein the lexical data include one or more keywords for a body type and a skin tone of a shopper or an ambassador.

12. The system of claim 1, wherein the list of recommended garments is stored in the data storage module and available for retrieval.

13. The system of claim 1, where the processing module is further configured to evaluate a status of a user based on a number of garments the user has purchased with the system or a number of garments the user has recommended on the system.

14. The system of claim 1, wherein a form and content of the GUI corresponds to the category of user.

15. The system of claim 1, wherein the user category further includes a financier to facilitate purchase transactions and revenue sharing between one or more of shoppers, ambassadors and merchants.

16. A method of automatically generating custom garment recommendations in real time for a shopper, the method comprising:
receiving one or more of image data, numerical data and lexical data related to a plurality of garment products from one or more ambassadors and merchants via corresponding forms of GUI, wherein the one or more of image data, numerical data and lexical data include at least one attribute associated with a garment product or an ambassador, and wherein the at least one attribute includes one or more of an age, a sex, a size measurement, a body type, a skin tone, a garment brand, a garment size category, a garment type, a garment color, a garment material, a garment-identifying code, and a price;
receiving a request for a garment recommendation from a shopper via a corresponding form of GUI, wherein the request includes one or more of image data, numerical data and lexical data, wherein the one or more of image data, numerical data and lexical data include at least one attribute associated with the shopper, and wherein the at least one attribute includes one or more of an age, a sex, a size measurement, a body type, a skin tone, a garment brand, a garment size category, a garment type, a garment color, a garment material, a garment-identifying code, and a price;
identifying a plurality of garments having at least one attribute associated with the one or more ambassadors and merchants that matches at least one attribute associated with the shopper;
determining a relevance score for each identified garment based on the number of matching attributes;
generating a list of a plurality of recommended garments ranked according to the relevance score of each identified garment with one or more of the image data, numerical data and lexical data associated with each identified garment; and
displaying the list via the GUI associated with the shopper.

17. The method of claim 16, wherein the one or more of image data, numerical data and lexical data received from the one or more ambassadors include a personal view of occasion, personality, material feel, material style, and a preferred brand or merchant of a garment, a photograph or a video of an ambassador wearing a garment, a photograph of a machine-readable identification code or an alphanumeric representation of the identification code of a garment, a size designation of a garment, a size metric, a weight, a height, a chest size, a waist size, a hip size and a sleeve length, and one or more keywords on a style, a color and a texture of a garment, and one or more keywords on an occasion for which a garment is best suited, and one or more keywords for a body type and a skin tone of a shopper or an ambassador.

18. The method of claim 16, further comprising:
storing the list of recommended garments in a data storage module.

19. The method of claim 16, further comprising:
evaluating a status of the shopper and the one or more ambassadors based on a number of garments the shopper has purchased and a number of garments the one or more ambassadors have recommended.

20. The method of claim 16, further comprising:
facilitating a purchase transaction and revenue sharing between the shopper, the one or more ambassadors and merchants via a financier.
